(19) United States
(12) Patent Application Publication
(10) Pub. No.: US 2026/0141206 A1
(43) Pub. Date: May 21, 2026

(54) DUAL-INTERFACE SMARTCARD WITH LIGHTING ELEMENT

(71) Applicant: LINXENS HOLDING, Mantes la Jolie (FR)

(72) Inventors: Carsten NIELAND, Dresden (DE); Lars KLEMM, Dresden (DE); Sven DOERING, Dresden (DE)

(21) Appl. No.: 19/119,684

(22) PCT Filed: Jan. 27, 2023
(86) PCT No.: PCT/IB2023/000026

§ 371 Date: Apr. 9, 2025

(30) Foreign Application Priority Data
Oct. 10, 2022 (EP) 22306520.2

(51) Int. Cl. G06K 19/07

(52) U.S. Cl. CPC G06K 19/0728

(57) ABSTRACT

The present invention relates to an electronic carrier for antennas for a smartcard comprising an antenna substrate, a first wire antenna configured to provide energy to a lighting element for a smartcard, and a second wire antenna configured to provide energy to an electronic module for contactless data transferfor a smartcard, wherein the first antenna and the second antenna are formed on opposite sides of the antenna substrate. The present invention also refers to a lighting device for a smartcard comprising a lighting element configured for illuminating a portion of the smartcard and a single diode suitable for providing energy to the lighting element when connected to an energy harvesting antenna. Furthermore, the present invention refers to a pre-laminated structure for a smartcard and a smartcard comprising said electronic carrier and/or said lighting device.

This application claims priority to International Application No. PCT/IB2023/000026, filed Jan. 27, 2023, which claims priority to European Patent Application No. 22 306 520.2, filed Oct. 10, 2022, the contents of which are incorporated by reference herein in its entirety.

The present invention refers to an electronic carrier and a pre-laminated structure for a smartcard containing a lighting element powered by a High-Frequency (HF) antenna. The present invention also refers to a lighting device comprising a lighting element to be incorporated into a smartcard.

OLEDs and other lighting devices in pre-laminated structure and smartcards usually require external rectifier components to be able to receive harvesting energy from a HF antenna, for example an antenna with a resonance frequency of approximately 13.56 MHz.

These solutions are generally based on the use of PCBs comprising the one or more antennas and the rectifier components, wherein the electronic components are typically produced by means of etching techniques.

When the pre-laminated structure and the smartcards with LED or OLED components are used in Dual Interface (DI) cards, there are two possible configurations for the harvesting HF antenna.

In the first configuration, a single antenna is provided in the pre-laminated structure and/or in the smartcard and said single antenna is used both for realizing the required data transfer for the contactless payment and for harvesting energy to the LED or OLED in the same contactless reader field.

In the second configuration, two antennas are provided in the pre-laminated structure and/or in the smartcard, i.e. an EMV antenna for contactless payments and an energy harvesting antenna (EH) for powering up the LED or OLED in the contactless reader field.

In both configurations, it is necessary that the dynamic data transfer for the contactless payment is not affected by the energy harvesting antenna consuming energy from the same ready field at the same time. In fact, if the two powering processes interfered with each other, the EMVco payment would be interrupted and the payment transaction would fail. It is hence clear that a very specific and complex system for the payment antenna and the harvesting antenna needs to be designed.

Both the single and the double antenna configurations present many disadvantages.

The single antenna configuration implies the realization of a very complex system, which must manage the modulation of the HF antenna to realize the dynamic data transfer for the contactless payment and, at the same time, it must provide enough energy to let the LED or OLED light up. In fact, no external batteries should be used to provide additional power to the LED or OLED.

The double antenna configuration requires less electronic complexity with respect to the single antenna configuration, but it requires at least four diodes and one capacitor to realize a full rectifier, in order to connect the energy harvesting antenna and the LED or OLED. Therefore, production costs remain high.

Moreover, since each micro-controller for contactless payments requires its own specific payment antenna and since the payment antennas may be made in different sizes, it is clear that a high variety of PCBs has to be made. These PCBs generally require large dimensions and do not comply with the dimensional standards for DI cards.

Another challenge is represented by the need to integrate the PCBs with the connected LEDs or OLEDs into a multi-layered pre-laminated structure and then into a card body.

In view of all the challenges depicted above, i.e. the high number of required electronic components, the large size of the PCBs and the difficulties for PCB integration, DI cards with LEDs or OLEDs are generally very expensive and cannot be produced on a high scale, so as to match the market demands.

It is therefore an object of the present invention to provide an electronic carrier for the antennas and a pre-laminated structure to be integrated into a DI smartcard that overcome one or more of the disadvantages illustrated above. Moreover, it is an object of the present invention to provide a lighting device comprising a lighting element to be integrated into a smart card, wherein the number of electronic components for the energy harvesting is reduced to the minimum. Accordingly, the size of the PCB may be reduced, so that it carries a single electronic component for the energy harvesting. According to alternative solutions, no PCB for carrying the electronic components for the energy harvesting may be needed.

The electronic carrier, the pre-laminated structure and the lighting device according to the present invention are as set-up in the appended claims.

In the following description, reference is made to the following figures:

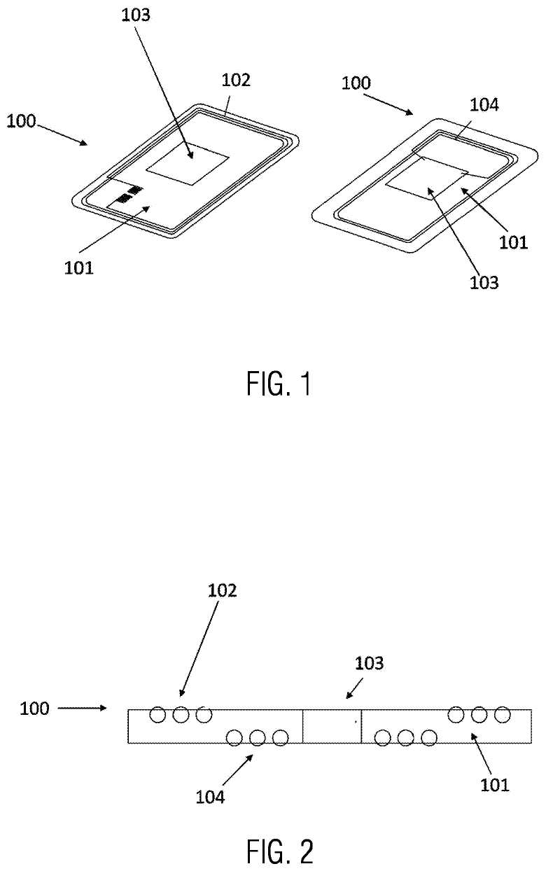

FIG. 1 schematically illustrates a three-dimensional view of a top side and a bottom side of an electronic carrier according to an embodiment of the present invention, wherein the perimeter of the energy harvesting antenna (EH) is smaller than the perimeter of the payment antenna.

FIG. 2 schematically illustrates a cross-section of the electronic carrier of FIG. 1.

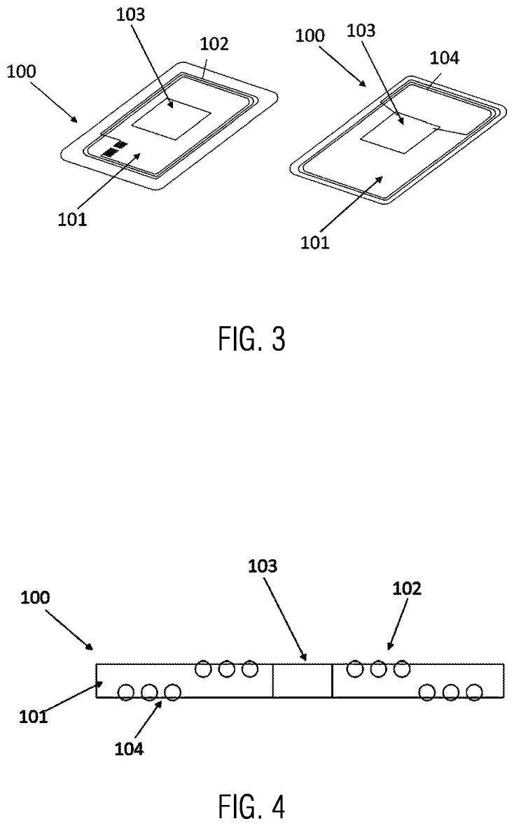

FIG. 3 schematically illustrates a three-dimensional view of a top side and a bottom side of an electronic carrier according to another embodiment of the present invention, wherein the perimeter of the EHA is larger than the perimeter of the payment antenna.

FIG. 4 schematically illustrates a cross-section of the electronic carrier of FIG. 3.

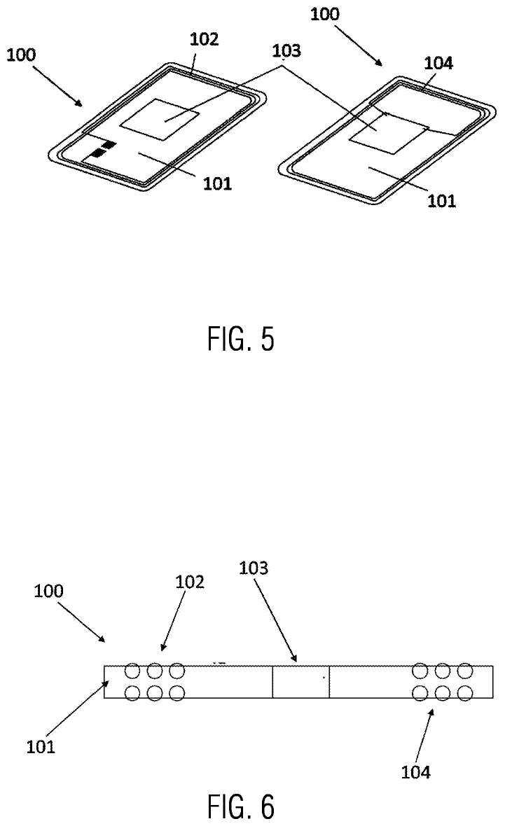

FIG. 5 schematically illustrates a three-dimensional view of a top side and a bottom side of an electronic carrier according to another embodiment of the present invention, wherein the EH antenna and the payment antenna have the same perimeter.

FIG. 6 schematically illustrates a cross-section of the electronic carrier of FIG. 5.

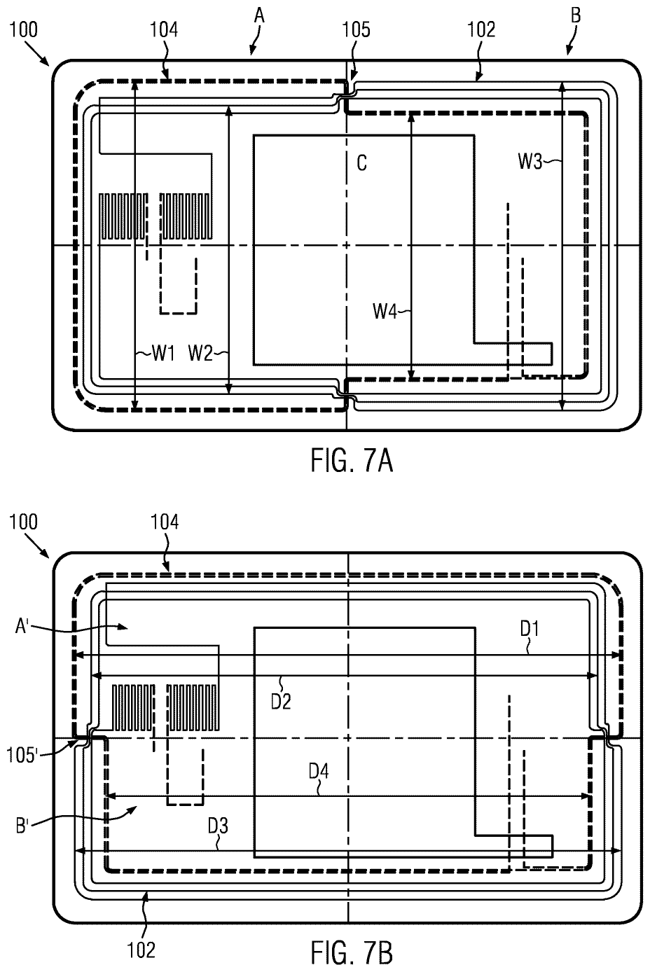

FIG. 7A schematically illustrates a top view of a side of an electronic carrier according to another embodiment of the present invention.

FIG. 7B schematically illustrates a top view of a side of an electronic carrier according to another embodiment of the present invention.

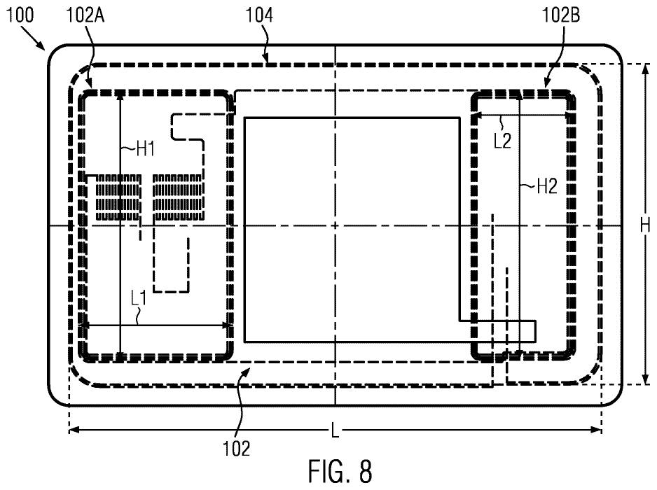

FIG. 8 schematically illustrates a top view of a side of an electronic carrier according to another embodiment of the present invention.

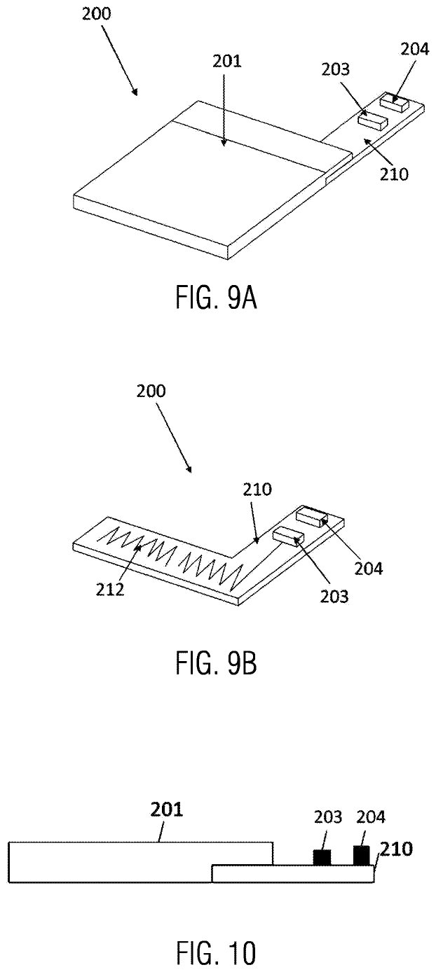

FIGS. 9A and 9B schematically illustrate a three-dimensional view of a lighting device comprising a lighting element, according to an embodiment of the present invention.

FIG. 10 schematically illustrates a cross-section of the lighting device, according to the embodiment of FIGS. 9A and 9B.

FIG. 11 schematically illustrates a top view of a lighting device comprising a lighting element, according to another embodiment of the present invention.

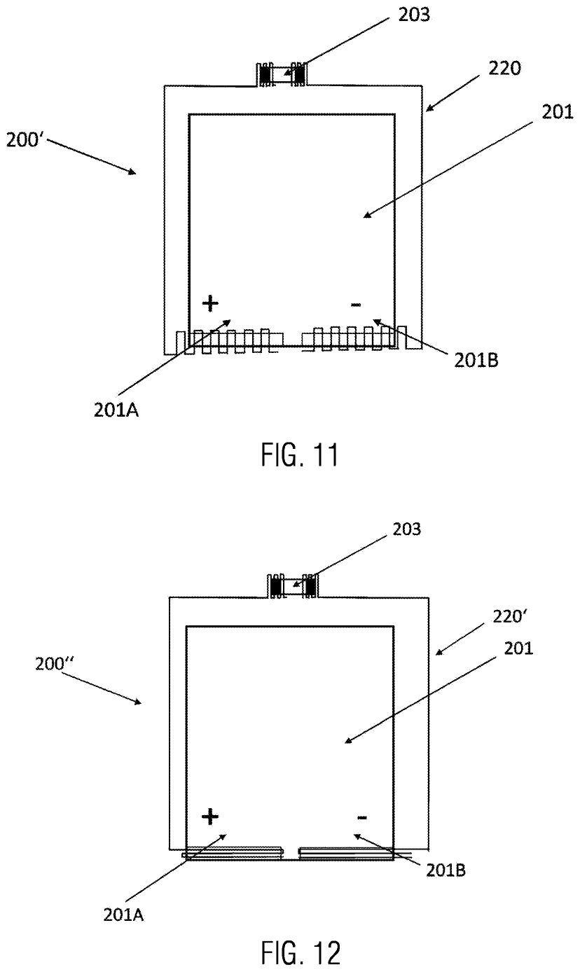

FIG. 12 schematically illustrates a top view of a lighting device comprising a lighting element according to another embodiment of the present invention.

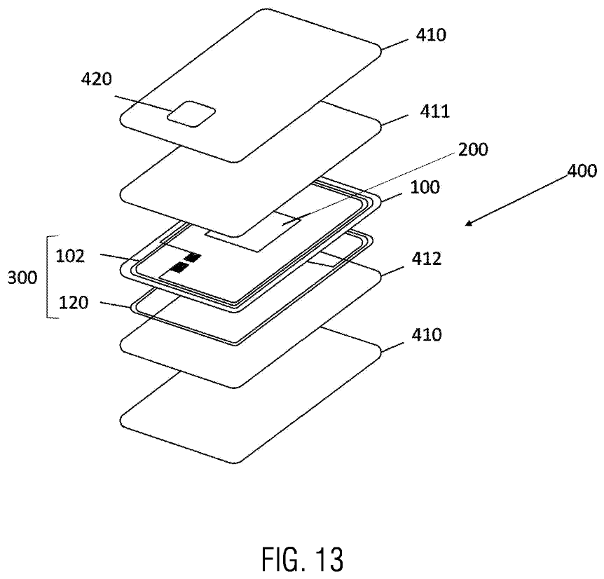

FIG. 13 schematically illustrates a three-dimensional view of a card-body for a smartcard according to an embodiment of the present invention.

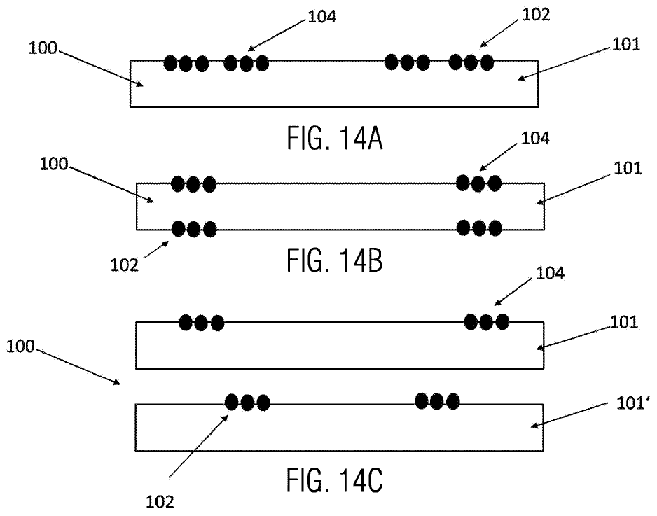

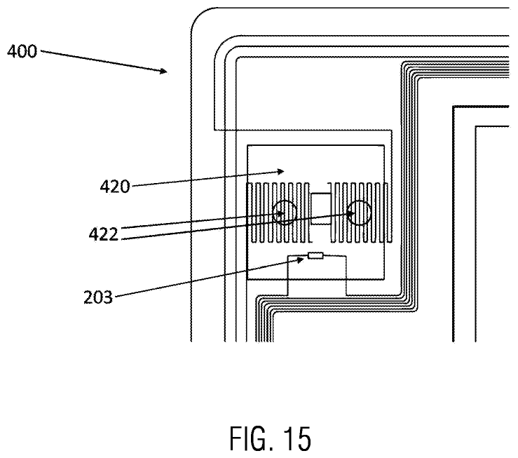

FIG. 14A schematically illustrates a cross-sectional view of a configuration of the electronic carrier according to an embodiment of the present invention, wherein the EH antenna and the payment antenna are formed on the same side of a single-layered electronic carrier.

FIG. 14B schematically illustrates a cross-sectional view of a configuration of the electronic carrier according to another embodiment of the present invention, wherein the EH antenna and the payment antenna are formed on different sides of a single-layered electronic carrier.

FIG. 14C schematically illustrates a cross-sectional view of a configuration of the electronic carrier according to another embodiment of the present invention, wherein the EH antenna and the payment antenna are formed on different sides of a multi-layered electronic carrier.

FIG. 15 schematically shows a top view of a portion of a smartcard, wherein the energy harvesting diode is integrated in the card module, according to an embodiment of the present invention.

The present description is presented for purposes of illustration, but is not intended to be exhaustive or limited to the disclosed embodiments. The scope of protection of the present disclosure is defined in the appended set of claims. Many modifications and variations will be apparent to those of ordinary skill in the art without departing from the scope of the disclosure. The embodiments were chosen and described in order to best explain the principles of the disclosure and the practical application, and to enable others of ordinary skill in the art to understand the disclosure for various embodiments with various modifications as are suited to the particular use contemplated. Finally, those fields considered known to the skilled person will not be described to avoid covering in a useless way the described invention.

In the present disclosure, it is to be understood that, the terms “top”, “bottom”, “up”, “down”, “front”, “back”, “right”, “left”, etc., must be interpreted with reference to the enclosed set of figures. However, it is to be understood that, in the context of the present disclosure, there is no preferred orientation of the electronic carrier, the lighting device, the pre-laminated structure and/or the smart card according to the embodiments described below.

In the following, the present invention is explained with reference to the enclosed figures.

FIG. 1 schematically illustrates a three-dimensional view of a top side (on the left) and a bottom side (on the right) of an electronic carrier 100 according to an embodiment of the present invention, wherein the perimeter of the EH antenna 104 for powering up the lighting element is smaller than the perimeter of the payment antenna 102. In other words, the EH antenna 104 and the payment antenna 102 are concentric with each other and the dimensions of the EH antenna 104 are smaller than the dimensions of the payment antenna 102. The payment antenna 102 may be an EMV antenna.

The electronic carrier 100 comprises a main body 101 made of plastic, such as PVC. The electronic carrier 100 comprises a cutout portion 103 configured to accommodate a lighting device comprising a lighting element. For example, the cutout portion 103 could accommodate the lighting device 200 described with reference to FIGS. 9A, 9B, 10-12. The main body 101 forms the substrate for the antennas.

The EH antenna 104 and the payment antenna 102 may be wire antennas and they may be made by means of wire embedding or air coil technology. The wire may be isolated or non-isolated and it may be made of copper, aluminum, and/or metal alloys with low specific electrical resistance. The advantage of realizing the antennas by means of wire embedding technology is that there is more flexibility in the antenna designs and that production costs are reduced.

In the configuration of FIG. 1, the EH antenna 104 and the payment antenna 102 are placed on opposite sides of the electronic carrier 100. In particular, the payment antenna 102 is placed on the top side of the electronic carrier 100 and the EH antenna 104 is placed on the down side of the electronic carrier 100. In another configurations (not shown), the EH antenna 104 and the payment antenna 102 may be on the same level on a single side of an electronic carrier 100. In another configurations (not shown), the EH antenna 104 and the payment antenna 102 may be formed on different sides of two different electronic carriers.

Preferably, the wire diameter of the payment antenna and of the EH antenna is comprised in the range between 50 μm and 200 μm.

According to a preferred embodiment, the EH antenna and the payment antenna may be HF antennas. Preferably, the resonance frequency of the payment antenna is comprised in range of between 14 MHz and 18 MHZ. Preferably, the resonance frequency of the EH antenna is comprised in range of between 13.56 and 28 MHz.

FIG. 2 schematically illustrates a cross-section of the electronic carrier 100 according to the embodiment of FIG. 1, wherein it is possible to see that the perimeter of the EH antenna 104 for powering up the lighting element is smaller than the perimeter of the payment antenna 102.

FIG. 3 schematically illustrates a three-dimensional view of a top side (on the left) and a bottom side (on the right) of an electronic carrier 100 according to another embodiment of the present invention, wherein the perimeter of the EH antenna 104 is larger than the perimeter of the payment antenna 102. In other words, the EH antenna 104 and the payment antenna 102 are concentric with each other and the dimensions of the payment antenna 102 are smaller than the dimensions of the EH antenna 104. The relation between the dimensions of the two antennas can be also seen in the cross-sectional view of FIG. 4.

FIG. 5 schematically illustrates a three-dimensional view of a top side (on the left) and a bottom side (on the right) of an electronic carrier 100 according to another embodiment of the present invention, wherein the perimeter of the EH antenna 104 is equal to the perimeter of the payment antenna 102. In other words, the EH antenna 104 and the payment antenna 102 are concentric with each other and they have the same dimensions. The relation between the dimensions of the two antennas can be also seen in the cross-sectional view of FIG. 6.

FIG. 7A schematically illustrates a top view of a side of an electronic carrier 100 according to another embodiment of the present invention, wherein the area of the electronic carrier 100 is ideally divided into two parts. In other words, the area of the electronic carrier 100 comprises a first part A and a second part B and the first antenna or EH antenna 104 surrounds the second antenna or payment antenna 102 in the first part A and the second antenna 102 surrounds the first antenna 104 in the second part B, so that the first antenna 104 cross-links the second antenna 102. The area of the electronic carrier 100 is divided into two parts by an ideal line and the first antenna 102 cross-links the second antenna 104 in correspondence of said ideal line.

In the configuration shown in FIG. 7A, the area of the electronic carrier 100 is ideally divided into two symmetric parts, i.e. a left part A and a right part B, with respect to a vertical symmetry line C. However, this configuration is not limiting and the two parts A and B could be non-symmetric with each other and could have different dimensions, for instance different widths and/or different lengths. Moreover, the two parts A and B could be defined with respect to an ideal vertical line parallel to the symmetry line C and/or with respect to an ideal horizontal line perpendicular to the symmetry line C.

In the left part A of the electronic carrier 100, the EH antenna 104 surrounds the payment antenna 102, whereas in the right part B of the electronic carrier 100 the payment antenna 102 surrounds the EH antenna 104, so that the payment antenna 102 cross-links the EH antenna 104 in correspondence of the symmetry line C and defines a cross-link portion 105. In other words, a first width W1 of the EH antenna 104 in the left part A of the electronic carrier 100 is larger than a second width W2 of the payment antenna 102 in the left part A; in a similar way, a first width W3 of the payment antenna 102 in the right part B of the electronic carrier 100 is larger than a second width W4 of the EH antenna 104 in the right part B. Preferably, the first width W1 of the EH antenna 104 is equal to the first width W3 of the payment antenna 102 and the second width W4 of the EH antenna 104 is equal to the second width W2 of the payment antenna 102. In correspondence of the cross-link portion 105, the EH antenna 104 bends so as to reduce the width from the first value W1 to the second value W4. In a similar way, in correspondence of the cross-link portion 105, the payment antenna 102 bends so as to increase the width from the second width value W2 to the first width value W3. Preferably, the bending portion of the EH antenna 104 forms a line parallel to the symmetry line C. Preferably, the bending portion of the payment antenna 102 forms a line perpendicular to the symmetry line C.

This configuration is advantageous because it ensures an optimal performance of the payment antenna 102 during EMV payments. For instance, the EMVCo test may lead to a pass rate of 100%.

Even if FIG. 7A shows that the EH antenna 104 and the payment antenna 102 are formed on the same level on a single side of the electronic carrier 100, other configurations (not shown) are also possible, wherein the EH antenna 104 and the payment antenna 102 are formed on opposite sides of the electronic carrier or on two different sheets that are then coupled to form an electronic carrier.

FIG. 7B schematically illustrates an alternative configuration, wherein the area of the electronic carrier 100 is ideally divided into two symmetric parts, i.e. an upper part A′ and a lower part B′, with respect to a horizontal symmetry line C′.

In the upper part A′ of the electronic carrier 100, the EH antenna 104 surrounds the payment antenna 102, whereas in the lower part B′ of the electronic carrier 100 the payment antenna 102 surrounds the EH antenna 104, so that the payment antenna 102 cross-links the EH antenna 104 in correspondence of the symmetry line C′ and defines a cross-link portion 105′. In other words, a first length D1 of the EH antenna 104 in the upper part A′ of the electronic carrier 100 is larger than a second length D2 of the payment antenna 102 in the upper part A′; in a similar way, a first length D3 of the payment antenna 102 in the lower part B′ of the electronic carrier 100 is larger than a second length D4 of the EH antenna 104 in the lower part B′. Preferably, the first length D1 of the EH antenna 104 is equal to the first length D3 of the payment antenna 102 and the second length D4 of the EH antenna 104 is equal to the second length D2 of the payment antenna 102.

In the configuration shown in FIG. 7B, the area of the electronic carrier 100 is ideally divided into two symmetric parts, i.e. an upper part A′ and a lower part B′, with respect to a horizontal symmetry line C′. However, this configuration is not limiting and the two parts A′ and B′ could be non-symmetric with each other and could have different dimensions, for instance different widths and/or different lengths.

FIG. 8 schematically illustrates a preferred configuration of the electronic carrier 100, wherein the Energy Harvesting (EH) antenna 104 encircles the payment antenna 102 and the payment antenna 102 is formed by at least two parts of coils 102A and 102B, in order to improve the signal quality and to optimize EMV payments. In fact, a payment antenna comprising only one coil part would have less interference, but bad signal quality and could cause failure of the EMV payment.

The first coil 102A has a width H1 and a length L1. The second coil 102B has a width H2 and a length L2. Preferably, the width H1 of the first coil 102A is equal to the width H2 of the second coil 102B. The widths H1 and H2 are smaller than the width H of the EH antenna 104 encircling the two coils 102A and 102B of the payment antenna 102. Preferably, the length L1 of the first coil 102A is larger than the length L2 of the second coil 102B. The sum of the lengths L1 and L2 is smaller than the total length L of the EH antenna 104, so that the two coils 102A and 102B of the payment antenna 102 are encircled by the EH antenna 104. In a similar way, each of the widths H1 and H2 of the coils 102A and 102B is smaller than the width of the EH antenna 104, so that the two coils 102A and 102B of the payment antenna 102 are encircled by the EH antenna 104.

FIGS. 9A and 9B schematically illustrate a three-dimensional view of a lighting device 200 comprising a lighting element 201, according to an embodiment of the present invention.

In the present disclosure, the lighting element 201 may indicate a Nth-Degree Nano LED stamp, a LED array, a LED light guiding element that includes at least one LED as light source, and/or an Organic LED (OLED). The lighting element 201 may be used for instance for lighting up a predefined area of a smartcard, for instance for illuminating a portion with a logo. Alternatively, the lighting element 201 may be used for indicating a working condition of the smartcard, for instance for indicating a successful transaction.

According to a preferred embodiment of the present invention, the electronic components for harvesting energy to the lighting element 201 may include a single diode 203 in combination with an energy harvesting antenna. According to an alternative embodiment (shown in FIGS. 9A and 9B), the electronic components for harvesting energy to the lighting element 201 may include a diode 203 and a capacitor 204 in combination with an EH antenna. In this configuration, the diode is used to convert the AC voltage/current signal emitted from the EH antenna into a DC voltage/current signal, which can power up the lighting element, such as the OLED.

Preferably, the diode has a forward voltage lower than 350 mV at 3 V. Preferably, the diode has a forward current comprised in the range between 100 mA and 300 mA. Preferably, the diode has a reverse voltage comprised in the range between 10 V and 30 V. Preferably, the diode has a capacitance comprised in the range between 1 pF and 200 pF.

Preferably, the electronic components for harvesting energy to the lighting element 201 are formed on a flexible printed circuit board (PCB) 210. Since, according to the present invention, the number of electronic components for harvesting energy is reduced to a minimum number of one or two components, also the size of the PCB 210 carrying those components can be reduced. For example, if the number of energy harvesting components is reduced to one diode, the PCB 210 needs to accommodate only one diode and its dimensions can be accordingly reduced. For example, if the number of energy harvesting components is reduced to one diode and one capacitor, the PCB 210 needs to accommodate the diode and the capacitor and its dimensions can still be reduced with respect to the prior art. In this way, the production process is cheaper.

The flexible PCB 210 may be made of an epoxy glass tape, or polyimide, or a similar material. According to other examples, the flexible PCB may be made of pure metal plates, e. g. copper, or of a flat wire or a round wire attached onto a plastic sheet. According to other examples, the PCB 210 may be made of the same material as the electronic carrier 100, such as PVC.

The connection between the lighting element 201 and the flexible PCB 210 carrying the energy harvesting components is schematically illustrated in FIGS. 9A and 10. This connection may be realized by means of a conductive adhesive (ACF, ACP, ICP), by crimping or by simply pressing a rough surface of the electrodes 212 on the PCB 210 into the electrodes of the light device 200 during lamination.

Preferably, the connection between the flexible PCB 210 and the wire of the EH antenna 104 is made by means of micro welding, such as TC bond, ICA, soldering, and/or force fit connection.

The diode 203 and/or the capacitor 204 may be connected to the contact terminals of the lighting element 201 by using ACF, ACP, micro soldering, micro welding, ICA, or simply by means of a force fit contact.

FIG. 10 schematically illustrates a cross-section of the lighting element 201 and its connection to the flexible PCB 210 comprising the energy harvesting components 203 and 204, according to the embodiment of FIG. 9A.

According to alternative advantageous embodiments of the present invention, the diode 203 may not be placed on the flexible PCB 210 that will be electrically connected to the lighting element 201, but the diode 203 may be connected to the lighting device 200 by means of a wire, for instance a non-isolated wire. In this way, production costs are further reduced and the assembly process is simplified. In fact, according to this configuration, there are no additional costs for forming a separate PCB to carry the diode 203 and/or the capacitor 204.

Illustrative embodiments wherein the diode 203 is connected to the lighting element 201 by means of a wire are shown in FIGS. 11 and 12.

FIG. 11 schematically illustrates a top view of a lighting device 200′, wherein the connection between the diode 203 and the terminals 210A and 210B of the lighting element 201 is made by means of a wire 220 with a meander structure.

FIG. 12 schematically illustrates a top view of a lighting device 200″, wherein the connection between the diode 203 and the terminals 210A and 210B of the lighting element 201 is made by means of a wire 220′with a different meander structure. In the configuration of FIG. 10, the orientation of the wire meanders is different from the configuration of FIG. 9, in order to provide an improved (e.g. with lower resistance) and more reliable wire connection to the lighting element terminals.

Preferably, the wires 220, 220′comprise wire meander structures at both ends, i.e. at the end contacting the diode 203 and at the end contacting the terminals 210A and 210B of the lighting element 201, as can be seen in the FIGS. 11 and 12.

The electrical connection between the wire 220, 220′and the terminals 210A and 210B of the lighting element 201 may be advantageously made by means of micro-welding, ACF bonding, ACP bonding, isotropic adhesive, and/or force fit.

The wire 220, 220′is preferably positioned on the same layer where the wire EH antenna is formed.

The diode 203 is preferably placed on the same layer where the wire 220, 220′and the EH antenna are formed.

FIG. 13 schematically illustrates a three-dimensional view of a card-body 400 for a smartcard according to an embodiment of the present invention.

The card-body 400 comprises a pre-laminated structure 300 including an electronic carrier for the antennas and a lighting device.

For instance, the electronic carrier for the antennas may be the electronic carrier 100 described with reference to FIGS. 1-8. Alternately, the electronic carrier for the antennas may have a configuration as shown in FIGS. 14A-14C.

For instance, the lighting device may be a lighting device as described above with reference to FIGS. 9A, 9B, 10-12.

It is to be understood that, according to the present invention, any combination of the disclosed electronic carriers for the antennas (i.e. with different size and positions of the antennas) and of the disclosed lighting devices (i.e. different configurations of the diode) may be included in the smartcard. In the smartcard according to the invention, the diode 203 and/or the capacitor 204 for the lighting element 201 and the EH antenna 104 are advantageously made on two different carriers, i.e. the lighting device 200 and the electronic carrier 100, respectively.

The electronic carrier 100 comprises the two wire antennas, i.e. the EH antenna 104 and the payment antenna 102. The electronic carrier 100 may comprise a single layer or it may comprise a plurality of layers, such as layer 100 and layer 120 shown in FIG. 13. In the multi-layered configuration, the EH antenna 104 and the payment antenna 102 may be formed on two separate layers. For instance, these two separate layers may be adjacent layers (i.e. laminated to each other) or they may be separated by additional layers.

The electronic carrier 100 may be laminated to additional layers to form a pre-laminated structure or pre-lam 300. The pre-laminated structure 300 indicates a preliminary structure comprising a plurality of layers connected to each other by means of a hot lamination process prior to incorporation of the external layers of the smartcard.

The card-body 400 of FIG. 13 further includes a front layer 411, including a translucent foil with printed elements, and a back layer 412, including a colored foil, for instance a white foil, with printed elements. Furthermore, the card-body 400 includes a top and a bottom overlays 410. A cavity is formed into the card-body 400 in order to accommodate the ISO module 420 with the ID payment chip. For instance, the cavity may be formed by milling. The ISO module 420 may be visible from the top overlay 410. The ISO module 420 according to a preferred embodiment may include the energy harvesting components for the EH antenna, such as the diode and/or the capacitor.

In FIGS. 14A-14C, three different configurations for placing the EH antenna and the payment antenna are shown in cross-sectional view.

FIG. 14A schematically illustrates a cross-sectional view of a configuration of the electronic carrier 100 according to an embodiment of the present invention, wherein the EH antenna 104 and the payment antenna 102 are formed on the same side of the main body 101 of the electronic carrier 100. The electronic carrier 100 of FIG. 14A comprises a single layer.

It is clear that, even if it shown that the EH antenna 104 is formed within the perimeter of the payment antenna 102, also the opposite configuration, wherein the payment antenna 102 is formed within the perimeter of the EH antenna 104 is possible.

FIG. 14B schematically illustrates a cross-sectional view of a configuration of the electronic carrier 100 according to another embodiment of the present invention, wherein the EH antenna 104 and the payment antenna 102 are formed on different sides of the main body 101 of the electronic carrier 100. The electronic carrier 100 of FIG. 14B comprises a single layer.

It is clear that, even if FIG. 14B shows that the two antennas have the same dimensions, a configuration is also possible, wherein the two antennas have different dimensions, for instance the perimeter of the EH antenna 104 is smaller than the perimeter of the payment antenna 102, or vice versa.

FIG. 14C schematically illustrates a cross-sectional view of a configuration of the electronic carrier 100 according to another embodiment of the present invention, wherein the EH antenna 104 and the payment antenna 102 are formed on different sides of the multi-layered electronic carrier. The electronic carrier 100 of FIG. 14C comprises two layers 101, 101′and the payment antenna 102 and the EH antenna 104 are formed on the top sides of the layers 101 and 101′, respectively. Alternatively, the payment antenna 102 and the EH antenna 104 may be formed on the bottom sides of the layers 101 and 101′, respectively. According to another alternative embodiment, the payment antenna 102 may be formed on the top side of the layer 101 and the EH antenna 104 may be formed on the bottom side of the layer 101′, or vice versa.

According to an alternative embodiment, which is schematically shown in FIG. 15, the diode 203 may be formed on the ISO module 420 of the smartcard comprising the ID payment chip. In other words, according to this alternative configuration, the ISO module 420 of the card 400 may carry not only the ID payment chip, but also the diode 203 and the capacitor 204 to power up the lighting element 201. The diode 203 is placed on the backside of the ISO payment module 420 together with the payment chip. The connection between the diode 203 and/or the payment chip and the conductor lines of the ISO module 420 can be made by wire bonding, soldering, adhesive bonding or similar.

According to this embodiment, the diode 203 for the lighting element 201 and the EH antenna 104 are advantageously made on two different carriers, i.e. the ISO module 420 and the electronic carrier 100, respectively.

Two additional connecting pads 220 are provided on the ISO module 420 to connect the energy harvesting antenna 104 to the same module 420. In this way, there is no need to form a separate PCB carrying the diode, since all the electronic components are integrated in the single ISO module, therefore production costs are reduced.

According to this embodiment, the ISO module 420 comprises two IO terminals for connection to the payment antenna 104, two IO terminals for connection to the EH antenna 102 and two IO terminals for connection to the lighting element 201. The connection between the pad terminals for connection to the lighting element 201 and the meander wire of the lighting element 201 may be made by using ACF and/or ACP bonding, micro-welding, solder connection, isotropic adhesive connection or force fit connection. Preferably, an ACF connection is used. The module comprising all the electronics is integrated in the card-body at a later stage with respect to the lighting device 200.

1. (canceled)

2. The pre-laminated structure of claim 19, wherein a perimeter of said first antenna is smaller than a perimeter of said second antenna.

3. The pre-laminated structure of claim 19, wherein a perimeter of said first antenna is larger than a perimeter of said second antenna.

4. The pre-laminated structure of claim 3, wherein said second wire antenna comprises at least two coil parts.

5. The pre-laminated structure of claim 19, wherein an area of said electronic carrier is ideally divided into a first part and a second part by an ideal line and wherein said first antenna surrounds said second antenna in said first part and said second antenna surrounds said first antenna in said second part, so that said first antenna cross-links said second antenna in correspondence of said ideal line.

6. The pre-laminated structure of claim 5, wherein said ideal line is a symmetry line, so that said first part and said second part are symmetric with each other.

7. The pre-laminated structure of claim 5, wherein said area is rectangular and is defined by a first side and a second side and said ideal line is parallel to one of said first side and said second side.

8. (canceled)

9. (canceled)

10. The pre-laminated structure of claim 19, wherein said antenna substrate comprises a cutout portion for accommodating said lighting element.

11. A lighting device for a smartcard comprising the following elements:
A lighting element configured for illuminating a portion of said smartcard;
A single diode suitable for providing energy to said lighting element when connected to an energy harvesting antenna; and
A printed circuit board (PCB) connected to said lighting element,
wherein said single diode is formed on said PCB and an area of said PCB is designed to accommodate only said diode.

12. The lighting device according to claim 11, wherein said lighting element is a Nth-Degree Nano LED stamp, a LED array, a LED light guiding element including at least one LED as light source, and/or an Organic LED (OLED).

13. (canceled)

14. (canceled)

15. The lighting device according to claim 11, wherein said lighting device further comprises a substrate for said lighting element and said single diode and/or said capacitor are formed on a portion of said substrate and are connected to said lighting element by means of a wire.

16. The lighting device according to claim 15, wherein said wire has a meander structure.

17. The lighting device according to claim 11, wherein said diode and/or said capacitor are formed on an electronic module for contactless data transfer of said smartcard, for instance an ISO module.

18. (canceled)

19. A pre-laminated structure for a smartcard comprising:
a lighting device comprising:
a lighting element configured for illuminating a portion of said smartcard,
a single diode suitable for providing energy to said lighting element when connected to an energy harvesting antenna, and
a printed circuit board (PCB) connected to said lighting element,
wherein said single diode is formed on said PCB and an area of said PCB is designed to accommodate only said diode; and
an electronic carrier for antennas comprising an antenna substrate, a first wire antenna configured to provide energy to said lighting element of said lighting device, and a second wire antenna configured to provide energy to an electronic module for contactless data transfer for a smartcard.

20. The pre-laminated structure of claim 19, wherein said antenna substrate comprises a single layer and said first antenna and said second antenna are formed on the same side of said single layer.

21. The pre-laminated structure of claim 19, wherein said antenna substrate comprises a plurality of layers and said first antenna and said second antenna are formed on different layers of said plurality of layers.

22. A smartcard comprising the following elements:
a pre-laminated structure comprising:
a lighting device comprising:
a lighting element configured for illuminating a portion of said smartcard,
a single diode suitable for providing energy to said lighting element when connected to an energy harvesting antenna, and
a printed circuit board (PCB) connected to said lighting element,
wherein said single diode is formed on said PCB and an area of said PCB is designed to accommodate only said diode, and
an electronic carrier for antennas comprising an antenna substrate, a first wire antenna configured to provide energy to said lighting element of said lighting device, and a second wire antenna configured to provide energy to an electronic module for contactless data transfer for a smartcard; and
one or more printed layers comprising printed information;
one or more overlays superimposed on said one or more printed layers; and
an ISO module for contactless transactions.

23. The smartcard according to claim 22, wherein said diode of said lighting device is formed on said ISO module.

24. The pre-laminated structure of claim 19, wherein said antenna substrate comprises a single layer and said first antenna and said second antenna are formed on opposite sides of said antenna substrate.

25. The pre-laminated structure of claim 19, wherein said antenna substrate comprises a plurality of layers and said first antenna is formed on a first layer and said second antenna is formed on a second layer, so that, when said first layer is coupled to said second layer, said first antenna and said second antenna result on opposite sides of said antenna substrate.

26. A lighting device for a smartcard comprising the following elements:
a lighting element configured for illuminating a portion of said smartcard;
a single diode and a capacitor suitable for providing energy to said lighting element in combination with each other, when connected to an energy harvesting antenna;
a printed circuit board (PCB) connected to said lighting element,
wherein said single diode and said capacitor are formed on said PCB and an area of said PCB is designed to accommodate only said diode and said capacitor.
